(19) United States
(12) Patent Application Publication
(10) Pub. No.: US 2012/0248335 A1
(43) Pub. Date: Oct. 4, 2012

(54) METHOD AND APPARATUS FOR INSPECTING SOLAR CELL

(75) Inventors: Jae Hoon KIM, Seoul (KR); Jin Mun Ryu, Gyeonggi-do (KR); Seung Yun Oh, Gyeonggi-do (KR); In Taek Song, Gyeonggi-do (KR); Tae Young Kim, Seoul (KR)

(73) Assignee: SAMSUNG ELECTRO-MECHANICS CO., LTD.

(21) Appl. No.: 13/402,534

(22) Filed: Feb. 22, 2012

(30) Foreign Application Priority Data
Apr. 4, 2011 (KR) 10-2011-0030680

(51) Int. Cl. G01N 21/64

(52) U.S. Cl. 250/459.1; 250/458.1; 250/208.1

(57) ABSTRACT

Disclosed herein are a method and an apparatus for inspecting solar cells. According to an exemplary embodiment of the present invention, a method for inspecting solar cells includes: (a) preparing solar cells; (b) obtaining a photoluminescence image(s) by irradiating light to the prepared solar cells; and (c) determining a conversion efficiency rating of each solar cell according to brightness of the obtained image. Further, an apparatus for inspecting solar cells includes a stage unit that transfers solar cells; a light source unit that irradiates light to a surface of the solar cell transferred through the stage unit; a camera unit that obtains a photoluminescence image according to the light irradiated from the light source unit; and an efficiency determination unit that determines a conversion efficiency rating of each solar cell based on brightness of an image obtained from the camera unit according to preset programs.

### CROSS REFERENCE(S) TO RELATED APPLICATIONS

This application claims the benefit under 35 U.S.C. Section 119 of Korean Patent Application Serial No. 10-2011-0030680, entitled “Method And Apparatus For Inspecting Solar Cell” filed on Apr. 4, 2011, which is hereby incorporated by reference in its entirety into this application.

### BACKGROUND OF THE INVENTION

1. Technical Field

The present invention relates to a method and an apparatus for inspecting solar cells. More particularly, the present invention relates to a method and an apparatus for inspecting solar cells capable of easily and simply determining photoelectric conversion efficiency of the solar cell using a PL image rather than using a solar simulator as a unit for determining the photoelectric conversion efficiency of the solar cell.

2. Description of the Related Art

Recently, research and development of a solar cell as clean energy source has actively progressed due to an increase in oil price, depletion of fossil fuels, environmental problems, or the like. Application fields of the solar cell have also been widely applied from power generation to general electronic devices. Solar energy conversion efficiency has considerably improved due to the development of technology and as a result, in a laboratory, a high efficiency cell of 23% or more has been developed.

The solar cell is a device that converts light energy into electric energy using a photoelectric effect or a photovoltaic effect. The solar cell is classified into a silicon solar cell, a thin film solar cell, a dye sensitized solar cell, an organic polymer solar cell, or the like, according to the structure material thereof. Today, a silicon solar cell dominates the market. The silicon solar cell is generally configured of a semiconductor in which a p-n junction is made. Further, a solar cell module is formed by connecting the solar cells in parallel or in series according to required electric capacity.

Voltage that can be generated by the solar cell is affected by the used semiconductor material. Generally, about 0.5 V is generated in the case of using silicon. However, cells connected to each other in series are generally used so as to obtain higher voltage.

Generally, the solar cell used for electronic devices is manufactured as a module. In order to manufacture the solar cell as the module, it is preferable to manufacture the module using the plurality of solar cells having the predetermined photoelectric conversion efficiency. Therefore, there is a need to determine the photoelectric conversion efficiency for the solar cells before manufacturing the module.

### SUMMARY OF THE INVENTION

An object of the present invention is to provide a method and an apparatus for inspecting solar cells capable of easily and simply determining photoelectric conversion efficiency of solar cells configuring a solar cell module while manufacturing the solar cell module.

According to an exemplary embodiment of the present invention, there is provided a method for inspecting solar cells, including: (a) preparing solar cells; (b) obtaining a photoluminescence image(s) by irradiating light to the prepared solar cells; and (c) determining a conversion efficiency rating of each solar cell according to brightness of the obtained image.

At step (c), the conversion efficiency rating of each solar cell may be determined according to a gray level of the image obtained at the previous step.

At step (c), the conversion efficiency rating of each solar cell may be determined according to values obtained by measuring and averaging the gray level of the obtained image in a plurality of pixel units for each solar cell.

At step (c), the conversion efficiency rating may be determined according to the average of gray levels per solar cell by measuring an 8-bit gray level in the plurality of pixel units.

At step (c), the conversion efficiency rating may be determined by being divided into at least three level ratings.

The method for inspecting solar cells may further include dividing or separating the solar cells according to the conversion efficiency rating determined after step (c).

The method for inspecting solar cells may further include detecting defects of the solar cell by determining the obtained image after step (b).

The detecting of the defects may be performed before step (c) or may be performed simultaneously with the determining of the conversion efficiency rating at step (c).

The defects may be defects due to cracks, chipping, or foreign objects.

According to another exemplary embodiment of the present invention, there is provided an apparatus for inspecting solar cells, including: a stage unit that transfers solar cells; a light source unit that irradiates light to a surface of the solar cell transferred through the stage unit; a camera unit that obtains a photoluminescence image according to the light irradiated from the light source unit; and an efficiency determination unit that determines a conversion efficiency rating of each solar cell based on brightness of an image obtained from the camera unit according to preset programs.

The efficiency determination unit may determine the conversion efficiency rating of each solar cell according to a gray level of the obtained image.

The efficiency determination unit may determine the conversion efficiency rating of each solar cell according to values obtained by measuring and averaging the gray level of the obtained image in a plurality of pixel units for each solar cell.

The efficiency determination unit may determine the conversion efficiency rating according to the average of gray levels per solar cell by measuring an 8-bit gray level in the plurality of pixel units.

The efficiency determination unit may further detect defects caused by cracks, chipping or foreign objects of the solar cell from the obtained image according to preset programs.

The apparatus for inspecting solar cells may further include a cell separation unit that divides or separates the solar cell according to the conversion efficiency rating determined by the efficiency determination unit.

The camera unit may include a filter that filters light emitted from the solar cell; a lens for focusing; and a camera that obtains a light-emitted image.

The stage unit may include a jig that fixes the solar cell; and a conveyor that moves the fixed solar cell.

Although not specifically stated as an aspect of the present invention, exemplary embodiments of the present invention according to possible various combinations of above-mentioned technical characteristics may be supported by the following specific exemplary embodiments and may be obviously implemented by those skilled in the art.

### BRIEF DESCRIPTION OF THE DRAWINGS

FIG. 1 is a flow chart schematically showing a method for inspecting solar cells according to an exemplary embodiment of the present invention.

FIG. 2 is a flow chart schematically showing some processes of the method for inspecting solar cells according to the exemplary embodiment of the present invention.

FIG. 3 is a flow chart schematically showing a method for inspecting solar cells according to another exemplary embodiment of the present invention.

FIG. 4 is a flow chart schematically showing the method for inspecting solar cells according to another exemplary embodiment of the present invention.

FIG. 5 is a graph showing a correlation between a gray level and a photoelectric conversion efficiency of a PL image of the solar cell.

FIG. 6 is a diagram schematically showing an apparatus for inspecting solar cells according to another exemplary embodiment of the present invention.

### DESCRIPTION OF THE PREFERRED EMBODIMENTS

Exemplary embodiments of the present invention for accomplishing the above-mentioned objects will be described with reference to the accompanying drawings. In describing exemplary embodiments of the present invention, the same reference numerals will be used to describe the same components and an additional description that is overlapped or allow the meaning of the present invention to be restrictively interpreted will be omitted.

It will be understood that when an element is referred to as simply being “coupled to” or “connected to” another element rather than being “directly coupled to” or “directly connected to” another element in the present description, it can be directly connected with the other element or may be connected with another element, having other element coupled or connected therebetween, as long as it is not contradictory to the description or is opposite to the concept of the present invention.

Although a singular form is used in the present description, it may include a plural form as long as it is opposite to the concept of the present invention and is not contradictory in view of interpretation or is used as clearly different meaning. It should be understood that “include”, “have”, “comprise”, “be configured to include”, and the like, used in the present description do not exclude presence or addition of one or more other characteristic, component, or a combination thereof.

An exemplary embodiment of the present invention relates to an inspection method and an inspection apparatus capable of classifying raw materials (solar cell) before the manufacturing of solar cell module converting light energy into electric energy, which may be applied to general electronic devices, such as mobile phones, PDAs, MDs, CD players, MP3, notebook, digital camera, camcorder, or the like. The exemplary embodiment of the present invention may be applied to both of the solar cell for small electronic products and large systems, such as a solar cell for an electrical device and power generation, or the like.

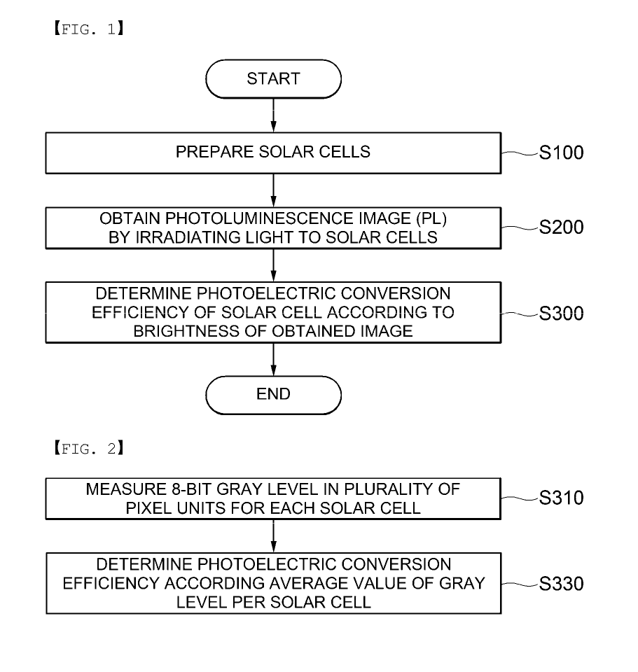

First, a method for inspecting solar cells according to an exemplary embodiment of the present invention will be described in detail with reference to FIGS. 1 to 4.

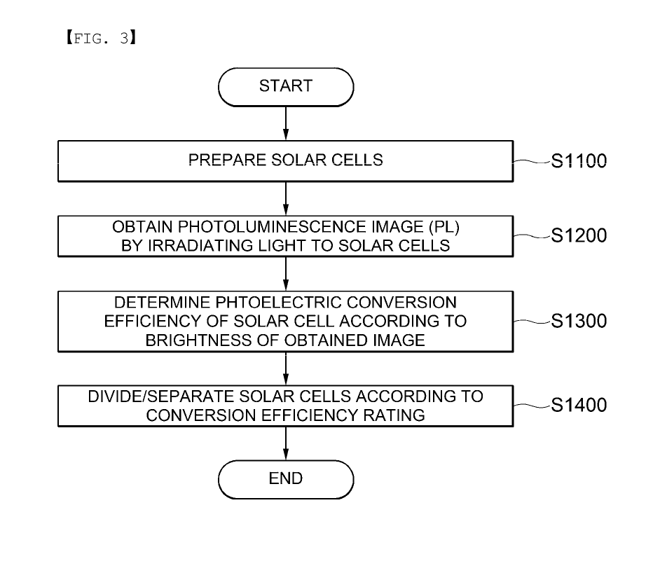

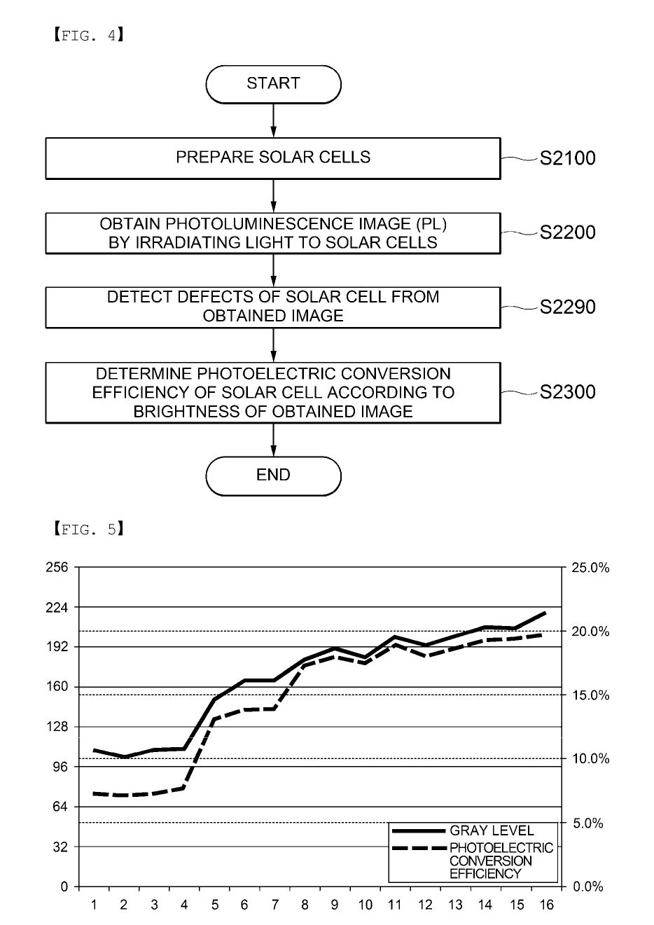

FIG. 1 is a flow chart schematically showing a method for inspecting solar cells according to an exemplary embodiment of the present invention, FIG. 2 is a flow chart schematically showing some processes of the method for inspecting solar cells according to the exemplary embodiment of the present invention, FIG. 3 is a flow chart schematically showing a method for inspecting solar cells according to another exemplary embodiment of the present invention, and FIG. 4 is a flow chart schematically showing the method for inspecting solar cells according to another exemplary embodiment of the present invention.

Referring to FIG. 1, a method for inspecting solar cells according to an exemplary embodiment of the present invention is configured to include the following steps (a) to (c) (S100 to S300).

At step (a) (S100), a solar cell 1 is prepared. The solar cell 1 may be one or plural cells. Preferably, when the solar cell 1 is small, a plurality of cells are prepared within a range in which a PL image can be obtained. The prepared solar cell 1 may be a solar cell that is already cut in an individual unit. Alternatively, the solar cell 1 may be a plurality of solar cells, which are not yet cut, on a substrate In the case of the already cut solar cell, the solar cell 1 may be a solar cell on which an electrode may be formed or an electrode may not be formed. In addition, the solar cell 1 may be a solar cell that is individually cut and may be a module unit in which a plurality of individual solar cells are coupled. Meanwhile, in the case of the solar cells, which are not yet cut, on the substrate, a cutting process after the process of the inspection method according to the exemplary embodiment of the present invention may be continued. Preferably, the solar cells 1 cut in an individual unit before the solar cell module is manufactured are prepared.

Next, at step (S200), light is irradiated to the prepared solar cell 1 to obtain a photo-luminescence image.

Photo-luminescence (PL) is a phenomenon of when the material is irradiated by light, the material emits light by itself. When light having larger energy than a band gap is irradiated to the solar cell, electrons within a material absorbs energy so as to be in an excitation state and the absorbed energy is emitted in a light type so as to return to an original balance state. An internal state of a substrate, for example, band gap energy, crystallinity, or the like, may be inspected by using a series of physical phenomena. When a laser beam in a visible ray or ultraviolet range or strong LED light is irradiated to the substrate, electrons in a low energy state are excited in a high energy state and then, specific light corresponding to an energy level is emitted during a process of de-exciting or recombining the excited electrons. In this case, a method of analyzing a substrate by analyzing spectra that is obtained by measuring the emitted light is a PL process. The PL process will be briefly described. First, when a laser beam is irradiated to the substrate, electrons in a valence band are excited to a conduction band. The excited electrons fall into a conduction band edge by vibration relaxation immediately after the excited electrons in the conduction band are generally in the high energy level. Among them, the plurality of electrons again move to a donor state or an acceptor state that is present between the valence band and the conduction band and then, are recombined after a predetermined time elapses. Some of the energy emitted while being recombined through several paths is indicated in a light type and the spectra of light emitted according to the characteristics of the substrate is determined. The electronic structural characteristics, defect characteristics, light emitting characteristics, or the like, of the solid substrate may be analyzed by analyzing the spectra of light emitted by the above-mentioned process. The PL may observe characteristics without damaging the solar cell in a method of observing light emitted after irradiating laser to the substrate (solar cell) without needing to connect the electrodes, unlike electroluminescence (EL).

Further, at step (S300), it determines a photoelectric conversion efficiency rating of each solar cell 1 according to brightness of the obtained image. The inventors found the correlation between the PL image brightness and the photoelectric conversion efficiency of the solar cell to suggest an invention that can easily determine the photoelectric conversion efficiency of the solar cell according to the image brightness of the solar cell without using a solar simulation process.

The exemplary embodiment of the present invention easily determines, for example, the photoelectric conversion efficiency so as to separate the cells having different photoelectric conversion efficiency before the solar cell module is manufactured, such that the solar cell module having generally excellent and uniform efficiency may be manufactured.

Preferably, according to another exemplary embodiment of the present invention, at step (c) of determining the rating of photoelectric conversion efficiency, the rating of photoelectric conversion efficiency of the solar cell 1 is determined according to the gray level of the obtained image at step (S200) of obtaining the PL image.

More preferably, the conversion efficiency rating of the solar cell 1 is determined according to values obtained by measuring and averaging the gray level of the obtained image in a plurality of pixel units for each solar cell 1. That is, the gray level is measured and averaged in each pixel unit by separating the PL image from the solar cell 1 of which the photoelectric conversion efficiency is determined in the plurality of pixel units. The photoelectric conversion efficiency rating of the solar cell 1 is determined by the averaged value.

More preferably, referring to FIG. 2, 8-bit gray level is measured in the plurality of pixel units (S310) and the conversion efficiency rating is determined according to the average of the gray level per solar cell (S330). When being represented by the 8-bit gray level, the conversion efficiency rating is represented by 256 from 0 to 255.

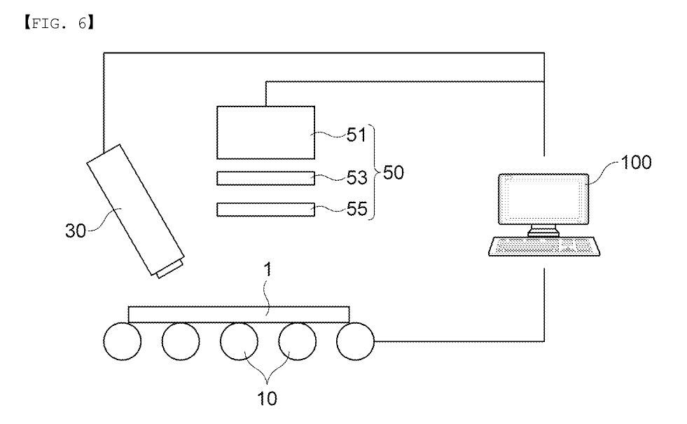

FIG. 5 is a graph showing the correlation between the gray level and the photoelectric conversion efficiency of the PL image of the solar cell. FIG. 5 shows the correlation between the 8-bit gray level and the photoelectric conversion efficiency of the PL image of the solar cell according to the following Table 1.

TABLE 1

| Substrate | Conversion | | | |
|---|---|---|---|---|
| Number | Efficiency | Imax | GL Range | Average GL |
| 1 | 7.3% | 58.92 | 100~119 | 109 |
| 2 | 7.1% | 55.89 | 93~113 | 103 |
| 3 | 7.3% | 57.87 | 86~123 | 109 |
| 4 | 7.7% | 57.00 | 93~121 | 110 |
| 5 | 13.1% | 73.38 | 120~163 | 149 |
| 6 | 13.8% | 76.17 | 143~177 | 164 |
| 7 | 13.9% | 74.63 | 144~179 | 164 |
| 8 | 17.3% | 93.83 | 163~195 | 181 |
| 9 | 17.9% | 92.55 | 170~201 | 190 |
| 10 | 17.4% | 92.18 | 167~198 | 183 |
| 11 | 18.8% | 96.69 | 181~214 | 199 |
| 12 | 18.0% | 96.72 | 174~208 | 192 |
| 13 | 18.7% | 96.63 | 178~211 | 199 |
| 14 | 19.3% | 95.61 | 191~222 | 207 |
| 15 | 19.4% | 98.61 | 179~220 | 206 |
| 16 | 19.7% | 98.78 | 199~237 | 219 |

In Table 1, Imax represents a current value according to an I-V test at maximum power and a unit is measured as mA. The GL range represents the range of the 8-bit gray level value in the image pixel unit of the substrate, that is, the solar cell and the average GL is an average of the gray level value at the corresponding substrate. Table 1 is results obtained by using a laser (optical fiber type, 808 nm, DC 45 W). From this, the correlation between the conversion efficiency of the solar cell and the GL of the PL image can be appreciated.

In FIG. 5, a horizontal axis represents the substrate number, a left vertical axis represents an average 8-bit gray level value of the substrate, and a right vertical axis represents the photoelectric conversion efficiency of the substrate. Referring to FIG. 5, it can be appreciated that the correlation between the gray level and the photoelectric conversion efficiency from a substrate subsequent to an eighth substrate is higher. Referring to Table 1, the eighth substrate represents the average gray level at 181 and the photoelectric conversion efficiency of 17.3%.

Preferably, the conversion efficiency rating may be determined by being divided into at least three level ratings. The rating may be divided into several levels based on the correlation between the photoelectric conversion efficiency and the gray level as needed. For example, in the case of the image brightness, for example, 8-bit gray level that may correspond to the photoelectric conversion efficiency of 17% or more, that is, in the case of approximately 180 as one example, the conversion efficiency may be determined to be a good rating.

Next, exemplary embodiments of the present invention will be described with reference to FIG. 3.

Preferably, according to another exemplary embodiment of the present invention, the method of inspecting solar cells further includes a step (S1400) of dividing or separating the solar cells according to the determined conversion efficiency rating after step (c) (S1300) of determining the conversion efficiency rating. The exemplary embodiment of the present invention separates the cells having different photoelectric conversion efficiency before the solar cell module is manufactured, such that the solar cell module can be manufactured with excellent and uniform efficiency.

Next, exemplary embodiments of the present invention will be described with reference to FIG. 4.

Referring to FIG. 4, another exemplary embodiment of the present invention further includes a step (S2290) of detecting defects of the solar cell by determining the obtained image after the step (S2200) of obtaining the PL image.

Preferably, according to the exemplary embodiment of the present invention, the detected defects may be defects due to cracks, chipping, or foreign objects.

Preferably, referring to FIG. 4, according to the exemplary embodiment of the present invention, the detecting of the defects is performed before step (c) (S2300). Alternatively, although not shown, the detecting of the defects is performed simultaneously with the process of determining the conversion efficiency rating at step (c).

Next, an apparatus for inspecting solar cells according to another exemplary embodiment of the present invention will be described with reference to the drawings. In understanding the operation of the apparatus for inspecting solar cells according to the exemplary embodiment of the present invention, the exemplary embodiment of the method for inspecting solar cells as described above needs to be referenced.

FIG. 6 is a diagram schematically showing an apparatus for inspecting solar cells according to another exemplary embodiment of the present invention.

Referring to FIG. 6, the apparatus for inspecting solar cells according to the exemplary embodiment of the present invention is configured to include a stage unit 10, a light source unit 30, a camera unit 50, and an efficiency determination unit (not shown). The efficiency determination unit may be included in a computer controller 100 of FIG. 6. Preferably, the computer controller 100 of FIG. 6 controls the operations of the stage unit 10, the light source unit 30, the camera unit 50, or/and the efficiency determination unit.

The stage unit 10 transfers the solar cell 1 for determining the photoelectric conversion efficiency through the PL. The solar cell 1 may be one or plural cells. The transferred solar cell 1 may be the solar cell that is already cut in an individual unit or may be the plurality of solar cells, which are not yet cut, on the substrate. Alternatively, the solar cell 1 may be the solar cell in the module unit in which the solar cells cut in a plurality of individual units are coupled. Preferably, the solar cells 1 cut in an individual unit before the solar cell module is manufactured are transferred through the stage unit 10.

Although not shown, according to the exemplary embodiment of the present invention, preferably, the stage unit 10 is configured to include a jig fixing the solar cell 1 and a conveyor moving the fixed solar cell 1. According to the exemplary embodiment of the present invention, the solar cell 1 is arrange in the jig (not shown) and the arranged jig moves to a PL system including the light source unit 30 and the camera unit 50 through the conveyor system.

When the solar cell 1 is transferred through the stage unit 10, the light source unit 30 irradiates light to the surface of the transferred solar cell 1. The light source unit 30 irradiates the laser beam in visible ray or ultraviolet range or a strong LED light to the solar cell.

The camera unit 50 obtains the photoluminescence image of the solar cell 1 according to light irradiated from the light source unit 30.

Preferably, referring to FIG. 6, according to the exemplary embodiment of the present invention, the camera unit 50 is configured to include a filter 55 filtering light emitted from the solar cell 1, a lens 53 for focusing, and a camera 51 obtaining the light-emitted image.

Although not shown, the efficiency determination unit determines the conversion efficiency rating of the solar cell 1 based on the image brightness obtained from the camera unit 50 according to preset programs. Preferably, the efficiency determination unit is included in the computer controller 100 of FIG. 6.

According to the exemplary embodiment of the present invention, the solar cells 1 may be efficiently divided and separated according to the efficiency by determining the rating by dividing the PL brightness of the obtained image.

That is, the exemplary embodiment of the present invention easily determines the photoelectric conversion efficiency so as to separate the cells having different photoelectric conversion efficiency before the solar cell module is manufactured, such that the solar cell module having generally excellent and uniform efficiency may be manufactured.

Preferably, according to another exemplary embodiment of the present invention, the efficiency determination unit (not shown) determines the conversion efficiency rating of the solar cell 1 according to the gray level of the obtained image.

More preferably, the efficiency determination unit (not shown) determines the conversion efficiency rating of the solar cell 1 according to the values obtained by measuring and averaging the gray level of the obtained image in the plurality of pixel units for each solar cell 1.

More preferably, the efficiency determination unit (not shown) measures the 8-bit gray level in the plurality of pixel units to determine the conversion efficiency rating according to the average of the gray level per solar cell 1. Measuring the 8-bit gray level in the plurality of pixel unit for the PL image corresponds to the already well known technology in an image processing technology field and therefore, the detailed description thereof will be omitted.

Preferably, according to the exemplary embodiment of the present invention, the efficiency determination unit (not shown) further detects defects due to cracks, chipping, or foreign objects of the solar cell 1 from the obtained image according to the preset programs. Defects occurring on the inside or the outside of the solar cell may be divided through the PL image.

Although not shown, according to another exemplary embodiment of the present invention, the above-mentioned apparatuses for inspecting solar cells are configured to further include a cell separation unit (not shown) dividing or separating the solar cells according to the conversion efficiency rating determined by the efficiency determination unit (not shown). The exemplary embodiment of the present invention separates the cells having different photoelectric conversion efficiency before the solar cell module is manufactured, such that the solar cell module can be manufactured with excellent and uniform efficiency.

As set forth above, the exemplary embodiment of the present invention can easily and simply determine the photoelectric conversion efficiency of the solar cells configuring the solar cell module during the manufacturing of the solar cell module.

The improved effects according to the exemplary embodiment are as follows. First, since the conversion efficiency measurement using the PL image is a nondestructive inspection, a conversion efficiency rating of the solar cell can be easily determined within a short period of process time without electrically connecting the solar cells through the general solar simulator and the defects of the solar cells due to the degradation in the conversion efficiency can be detected.

Second, the loss of unnecessary raw materials (solar cell) can be reduced and the defective incidence rate during the manufacturing of the module can be minimized.

It is obvious that various effects directly stated according to various exemplary embodiment of the present invention may be derived by those skilled in the art from various configurations according to the exemplary embodiments of the present invention.

The accompanying drawings and the above-mentioned exemplary embodiments have been illustratively provided in order to assist in understanding of those skilled in the art to which the present invention pertains. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, it will be apparent to those skilled in the art that various modifications, substitutions and equivalents can be made in the present invention without departing from the spirit or scope of the inventions.

What is claimed is:

1. A method for inspecting solar cells, comprising:
(a) preparing solar cells;
(b) obtaining a photoluminescence image(s) by irradiating light to the prepared solar cells; and
(c) determining a conversion efficiency rating of each solar cell according to brightness of the obtained image.

2. The method according to claim 1, wherein at step (c), the conversion efficiency rating of each solar cell is determined according to a gray level of the obtained image.

3. The method according to claim 2, wherein at step (c), the conversion efficiency rating of each solar cell is determined according to values obtained by measuring and averaging the gray level of the obtained image in a plurality of pixel units for each solar cell.

4. The method according to claim 3, wherein at step (c), the conversion efficiency rating is determined according to the average of the gray level per solar cell by measuring an 8-bit gray level in the plurality of pixel units.

5. The method according to claim 2, wherein at step (c), the conversion efficiency rating is determined by being divided into at least three level ratings.

6. The method according to claim 1, further comprising (d) dividing or separating the solar cells according to the conversion efficiency rating determined after step (c).

7. The method according to claim 1, further comprising detecting defects of the solar cell by determining the obtained image after step (b).

8. The method according to claim 2, further comprising detecting defects of the solar cell by determining the obtained image after step (b).

9. The method according to claim 6, further comprising detecting defects of the solar cell by determining the obtained image after step (b).

10. The method according to claim 7, wherein the detecting of the defects is performed before step (c) or is performed simultaneously with the determining of the conversion efficiency rating at step (c).

11. The method according to claim 7, wherein the defects are defects caused by cracks, chipping, or foreign objects.

12. An apparatus for inspecting solar cells, comprising:
a stage unit that transfers solar cells;
a light source unit that irradiates light to a surface of the solar cell transferred through the stage unit;
a camera unit that obtains a photoluminescence image according to the light irradiated from the light source unit; and
an efficiency determination unit that determines a conversion efficiency rating of each solar cell based on brightness of an image obtained from the camera unit according to preset programs.

13. The apparatus according to claim 12, wherein the efficiency determination unit determines the conversion efficiency rating of each solar cell according to a gray level of the obtained image.

14. The apparatus according to claim 12, wherein the efficiency determination unit determines the conversion efficiency rating of each solar cell according to values obtained by measuring and averaging the gray level of the obtained image in a plurality of pixel units for each solar cell.

15. The apparatus according to claim 14, wherein the efficiency determination unit determines the conversion efficiency rating according to the average of the gray level per the solar cell by measuring an 8-bit gray level in the plurality of pixel units.

16. The apparatus according to claim 12, wherein the efficiency determination unit further detects defects caused by cracks, chipping or foreign objects of the solar cell from the obtained image according to the preset programs.

17. The apparatus according to claim 12, further comprising a cell separation unit that divides or separates the solar cell according to the conversion efficiency rating determined by the efficiency determination unit.

18. The apparatus according to claim 12, wherein the camera unit includes a filter that filters light emitted from the solar cell; a lens for focusing; and a camera that obtains a light-emitted image.

19. The apparatus according to claim 12, wherein the stage unit includes a jig that fixes the solar cell; and a conveyor that moves the fixed solar cell.
